(19) United States
(12) Patent Application Publication
(10) Pub. No.: US 2017/0052524 A1
(43) Pub. Date: Feb. 23, 2017

(54) APPARATUS AND METHOD FOR UNIVERSAL SETUP, MONITORING AND CONTROL OF FIELD DEVICES FOR A PLANT

(71) Applicant: METSO AUTOMATION USA INC., Fergus Falls, MN (US)

(72) Inventors: Ross Kunz, Erhard, MN (US); Dominic Kunz, Fergus Falls, MN (US); Kyle Kraning, Battle Lake, MN (US); Wallace Stommes, Fergus Falls, MN (US)

(21) Appl. No.: 14/832,475

(22) Filed: Aug. 21, 2015

(51) Int. Cl. G05B 19/05

(52) U.S. Cl. CPC G05B 19/05; G05B 2219/1134

(57) ABSTRACT

Setup, monitoring and control of various field devices are provided using a general purpose, off-the-shelf mobile device such as a smartphone or tablet computer adapted by an application program to communicate using the Bluetooth communications protocol with communications and control modules attached to the field devices.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates to setting up, configuring, monitoring and controlling field devices for a plant. More specifically, the present invention relates to field devices in a plant and universal setting up, configuring, monitoring and controlling of such field devices wirelessly using a commercially available, of smartphone or tablet computer.

II. Related Art

Many manufacturing facilities and other plants utilize various types of field devices to control processes carried out in the plant. Typical examples of such field devices include valves, pumps, motors, conveyors, dampers and various other mechanical, electrical and electro-mechanical devices. Efforts to automate such plants are well known in the prior art. Such automation efforts typically involve the use of one or more distributed control systems (DCS) or programmable logic controllers .(PLC) to monitor and control the field devices. The DCS or PLC is typically hard-wired to the field devices to be controlled. The wires carry power, data and commands between the field devices and the PLC or DCS.

Various attempts have been made to provide wireless communications rather than wired communications. These wireless communications have typically been carried out using wireless wireless devices, i.e., wireless devices specifically designed to communicate with a specific field device. Since plants typically include different types of field devices, operators have been required to carry or have access to separate wireless devices matched to the different types of field devices.

Also, in the prior art, specialized master devices adapted for a specific field protocol have been used. These specialized master devices are designed to implement mission critical, plant specific, specialized operating protocols. As such, these devices tend to be quite cumbersome to use and are not suitable for more general use.

Instrument technicians and plant maintenance staff for many years have been looking for a single, wireless, commercially available, off-the-shelf device able to communicate with each of the various types of field devices used in various plants to setup, configure, monitor and control such field devices.

### SUMMARY OF THE INVENTION

The present invention solves the problems highlighted above by providing wireless setup, monitoring and control of many different types of field devices using a single smartphone such as an Apple® iPhone® or a single tablet computer such as an Apple® iPad®. This is achieved using Bluetooth® wireless technology built into the smartphone or tablet computer capable of carrying out two-way communications with controllers coupled directly into the field devices.

More specifically, a setup, monitor and control apparatus is provided. The apparatus includes a plurality of field devices which may be valves, motors, conveyors, dampeners or other mechanical, electrical and electro-mechanical devices used in a plant. Each of the field devices is coupled to a communications and control module (CCM). The field device is also typically coupled to at least one actuator controlling a function of the field device, and a sensor for monitoring a condition of either the field control device or the at least one actuator. The sensor is adapted to send signals to the CCM. The CCM is adapted to process such signals and control the operation of the at least one actuator. Further, the CCM includes a human machine interface (HMI), a processor, a clock, at least one memory module and a first short range radio adapted for two-way communication. A very suitable first short range radio is incorporated in a Bluetooth RF module. Bluetooth RF modules typically have a range of less than 100 meters. The processor, pursuant to a preselected set of instructions, is adapted to (i) store in said at least one memory module identification and address information concerning the field device and CCM, (ii) store information based on signals received from the at least one sensor and processed by the processor, (iii) send control signals to the at least one actuator, (iv) retrieve data from memory and transmit such data using the first short range radio, and (v) receive and process command signals received using the first short range radio.

The apparatus further comprises general purpose, commercially available, off-the-shelf mobile device (“GPMD”). Many GPMDs are suitable for use in non-hazardous operating environments. Many are also suitable for use, with or without modification, even in hazardous operating environments. When modification is required for use in hazardous environments, the modification may he as simple as providing a protective case for the GPMD. The GPMD may, for example, be a smartphone such as an Apple-iPhont® or a tablet computer such as an Apple® iPad®. Such GPMDs have a display, typically a touch screen display. Such GPMDs also include a second short range radio (most often a Bluetooth RF module) well-suited for communication with the first short range radio of each CCM attached to each of the plurality of field devices. When the GPMD and the CMM are within the range of the first and second short range radios, they are able to communicate with each other. Such GPMDs also include their own processor, memory module, user interface and operating system.

An important aspect of the present invention is the manner in the GPMD can be (and is) controlled, at least in part, by an application program which adapts the GPMD to interrogate each CCM in range of the first and second short range radio modules to retrieve and display identification information related to each such CCM. The user interface permits the GPMD, based on inputs from a user, to selectively send control signals to each such CCM. On a selective basis, the GPMD is also able to interrogate each such CCM to obtain and display information related to the operation of the field device attached to the CCM.

These and other attributes, features and advantages of the present invention will become more apparent to one skilled in the art from a review of the drawings provided herewith in conjunction with the detailed description provided below.

### BRIEF DESCRIPTION OF THE DRAWINGS

FIG. 1 is a block diagram of a plant capable of being monitored and, in some cases, controlled using a general purpose mobile device such as a smartphone or tablet computer;

FIG. 2 is a block diagram of a communications and control module, such modules are adapted and coupled to each of the field devices used in the plant;

FIG. 3 is a more detailed block diagram of an exemplary field device coupled to a communication and control module;

FIG. 4 is an example of the start screen displayed on a smartphone or tablet when a monitoring/control application is launched on the smartphone or tablet;

FIG. 5 is an example of a screen displayed when the application of FIG. 4 is operating and three field devices have been detected within the communication range of the Bluetooth radio in the cellphone or tablet computer;

FIGS. 6-9 show examples of screens that may be displayed on the smartphone or tablet when the top field device listed in FIG. 5 is selected;

FIG. 10 shows an example of a screen that may be displayed on the smartphone or tablet when the bottom field device listed in FIG. 5 is selected;

FIG. 11 shows a screen that may be displayed when the right arrow associated with the field device listed on the top of FIG. 5 is selected.

### DETAILED DESCRIPTION

This description of the preferred embodiment is intended to be read in connection with the accompanying drawings, which are to be considered part of the written description of this invention. In the description, relative terms such as “lower”, “upper”, “horizontal”, “vertical”, “above”, “below”, “up”, “down”, “top”, and “bottom”, as well as derivatives thereof (e.g., “horizontally”, “downwardly”, “upwardly”, etc.) should be construed to refer to the orientation as then described or as shown in the drawings under discussion. These relative terms are for convenience of the description and do not require that the apparatus be constructed or operated in the orientation shown in the drawings. Further, terms such as “connected”, “connecting”, “attached”, “attaching”, “joined”, and “joining” are used interchangeably and refer to one structure or surface being secured to another structure or surface or integrally fabricated in one piece, unless expressly described otherwise.

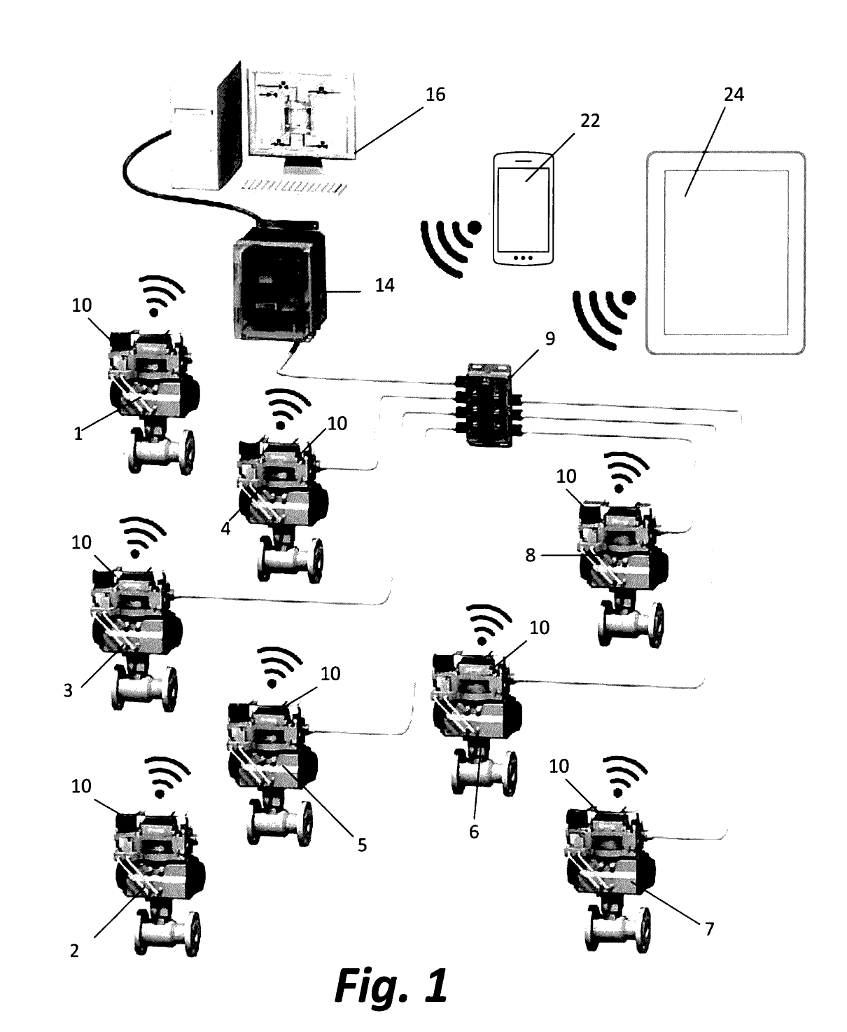

Eight field devices 1-8 are shown in FIG. 1, In the example shown, each field device is a manual or automated valve. Other types of field devices may be used instead of valves without deviating from the invention. Located at the top of each valve is a communications and control module (CCM) 10.

In FIG. 1, field devices 1 and 2 are separately powered such as by a battery or separate power supply (not shown). Field devices 1 and 2 are also not physically coupled to a data bus. Field devices 3-8, however, are wired by cables to a data switch 12 which is also wired to a PLC 14. The cables will typically be adapted to carry power to the field devices 3-8. Likewise, the cables will carry control and data signals between the PLC 14 and the field devices 3-8. The switch 12 is responsible for properly routing the signals between the PLC 14 and the correct field devices 3-8. The PLC 14 is coupled to a master computer 16 used to monitor the operation of and send instructions to the PLC. The PLC sends control signals to the CCMs 10 of field devices 3-8 which are processed by the CCMs 10 to control the operation of the attached field devices. As illustrated, the PLC 14 cannot send signals to or receive signals from the CCMs attached to field devices 1 and 2.

The CCMs 10 are capable of conducting two-way communications with a GPMD such as smartphone 22 or tablet computer computer 24 since each CCM 10 and each such smartphone and tablet computer are equipped with a Bluetooth RF module. A unique software application loaded onto the smartphone 22 or tablet computer 24 permits the smartphone 22 or tablet computer 24 to collect and process signals from the CCM 10 of each of the field devices 1-8 within the range of the Bluetooth RF Modules of the CCM and the GPMD. The range of such modules is typically less than 100 meters. The GPMD (smartphone 22 or tablet computer 24) processes those signals to display information related to the identity and status of each such CCM and attached field devices 1-8. The application also permits the user of smartphone 22 or tablet 24 to send commands and data to and receive data from the individual CCMs 10 associated with the field devices 1-8.

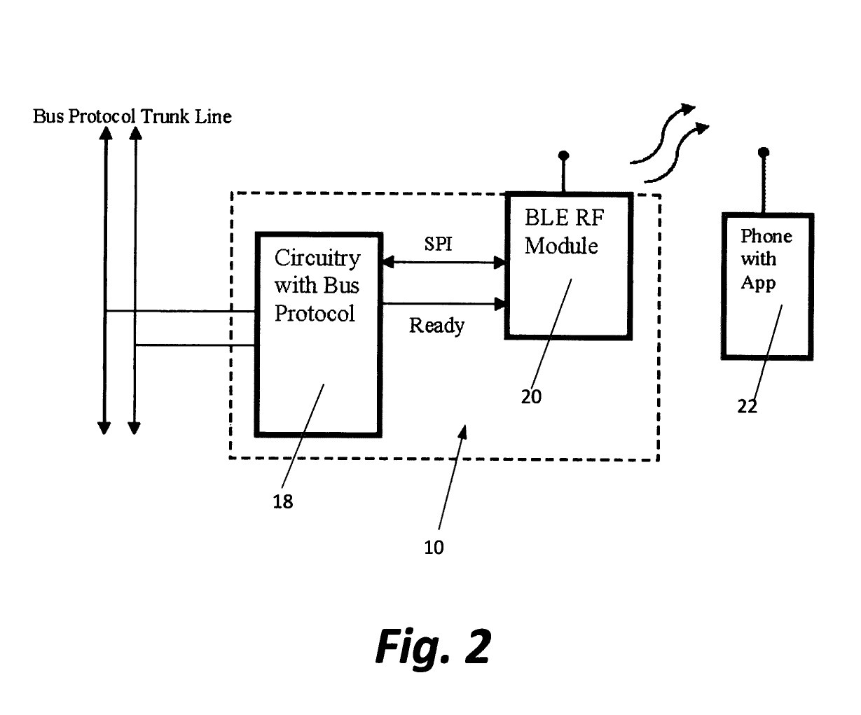

FIG. 1 shows a smartphone 22 and tablet computer 24 on which the application has been installed communicating via Bluetooth with the CCMs 10 of any of the field devices 1-8. As shown FIG. 2 and as discussed above, each CCM 10 has a Bluetooth RF module 20 which passes signals between the GPMD (smartphone 22 or tablet computer 24) and the field device controller 16. FIG. 2 also shows that the field device controller 16 is coupled to the _{:}bus line (wiring) used to couple the CCMs 10 associated with field devices 3-8 to the switch 12 and the PLC 14. This connection is not present with respect to the CCMs 10 associated with field devices 1 and 2.

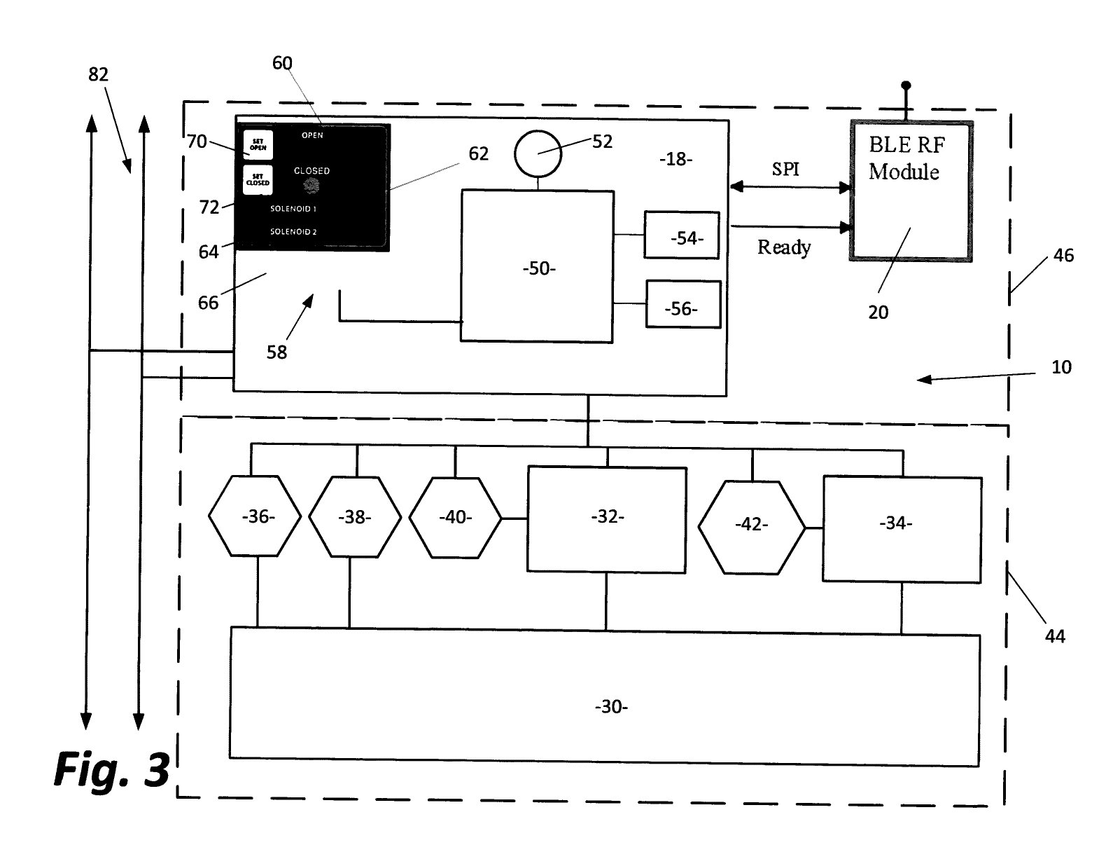

FIG. 3 shows a generic field device 30 coupled to a CCM 10. The field device 30, as noted above, can be a valve, motor, damper, conveyor or some other electrical, mechanical or electro-mechanical device. An actuator may coupled to the field device. Boxes 32 and 34 in FIG. 3 represent two such actuators. If the generic field device 30 is a valve, the actuators 32 and 34 could, for example, be solenoids adapted to open and close the valve.

For automated control of a field device 30, it is also necessary to sense the operating condition of the field device 30 or the actuators 32 and 34. A sensor 36, which may be a temperature sensor, is shown in FIG. 3 sensing the condition of field device 30. A sensor 38, which may be a position sensor, is shown in FIG. 3 also sensing a condition of the field device 30. Sensor 40 senses the operating condition of the actuator 32. Likewise, sensor 42 senses the operating condition of actuator 34. While FIG. 3 shows the actuators 32 and 34 and the sensors 36-42 position within a housing 44 surrounding the field device 30, the actuators and sensors could also be positioned within the housing 46 of the CCM 10. Additional or different actuators and sensors may be employed depending on the nature of field device 30.

Control of the actuators 32 and 34 to thereby control operation of the field device 30 is provided by the field device controller 18 of the CCM 10. Controller 18 comprises a microprocessor or micro-controller module 50 (herein either of which are generically referred to as a processor), a clock 52, non-volatile memory module 54, a volatile memory module 56 and a human machine interface (HMI) 58. As illustrated, the HMI 58 includes a set of indicator lamps 60, 62, 64, 66 which provide the user with information regarding the operating condition of field device 30 and actuators 32 and 34. The indicator lamps may, for example, be light emitting diodes (LEDs). HMI 58 also includes a set of switches 70 and 72 which allow a user to set the operating condition of the field device 30 or control the actuators 32 and 34. Power is supplied to the field device 30 and to the attached CCM 10 by the bus 82. Alternatively, power can be supplied by a battery or by a separate electrical connector. The processor 50 performs a variety of control and reporting functions based upon a preprogrammed set of instructions stored in the non-volatile memory module 54, signals from the sensors 36-42, signals from the clock 52, signals from the HMI 58, commands received from the PLC 14 or the computer 16 via the PLC 14 shown in FIG. 1, and commands received from the smartphone 22 or tablet computer 24 shown in FIG. 1 via the Bluetooth RF module 20. Some of these control functions are discussed below.

Control functions performed by the processor 50 include sending signals to the actuators 32 and 34 to control the operation of the field device 30. The control functions performed by the processor also include controlling the operation of the LEDs 60-66 of the HMI 58 so that the LEDs properly indicate status information to a user who happens to be within the field of view. The control functions performed by processor 50 also may include locking switches (buttons) 70-72 of the HMI 58 to disable the functionality of the switches and unlocking the switches to restore their functionality.

Reporting functions performed by the processor 50 include polling the sensors and processing signals from the sensors, storing information derived from such processing in the volatile memory module 56 and sending such information to the HMI 58, the computer 16 when commanded to do so by the PLC 14 or to the smartphone 22 or tablet computer 24. By way of example, and without limitation, when the field device 30 is a valve, the processor 50 will illuminate the “open” LED 60 of the HMI 58 when the valve is open and illuminate the “closed” LED 62 of the HMI 58 when the valve is closed. Likewise, the processor 50 will illuminate the solenoid 1 LED 64 of the HMI 58 when actuator 32 is operating and the solenoid 2 LED 66 when the actuator 34 is operating. These LEDs are off when the actuators 32 and 34 are not operating.

Additionally, the processor 50 can record historical data related to the operations of the field device 30 and actuators 32 and 34 for later reporting. For example, if sensor 36 is a temperature sensor, the processor 50 may store in the non-volatile memory module 56 the current operating temperature of the field device 30, the highest operating temperature of the field device 30, the lowest operating temperature of the field device 30, or the operating temperature of the field device 30 at discrete time intervals based on signals from the sensor 36 and the clock 52. Likewise, the processor 50 can record in the non-volatile memory module 56 for later reporting information related to the operation of the actuators 32 and 34 based on signals from the sensors 40 and 42. Such information may include the number of times each actuator was operated and the time and duration of each such operation. Data from the sensor 38, when it is a position sensor, may be used to record the number of cycles of the field device 30 or whether the field device 30 is actually positioned (or otherwise operating) as desired. These signals can also be used by the processor 50 to provide feedback control to the actuators 32 and 34.

The raw or processed sensor data may be reported to the PLC 14 in real time, at pre-selected time intervals or upon requests that the processor 50 receives from the PLC. Likewise, the raw or processed sensor data may be transmitted by the processor 50, via the Bluetooth module 20, to the smartphone 22 or tablet computer 24.

In addition to processing and reporting data from the sensors, the processor can store, process, respond to and report instructions and data transmitted between the CCMs 10 and PLC 14 or between the CCMs 10 and the smartphone 22 or tablet computer 24. By way of example, the PLC 14 can send an instruction to the processor 50 controlling how the processor responds to instructions received from a smartphone 22 or tablet computer 24. More specifically, the PLC 14 can instruct the controller regarding what commands to accept and process from smartphones 22 or tablet computers 24 generally or from a specific smartphone 22 or tablet computer 24. The way in which the processor 50 is also adapted to respond to commands from the PLC 14 limiting the data shared with smartphones 22 and tablet computers 24 generally or with a specific smartphone 22 or tablet computer 24 is further explained below.

The memory modules of 54 and 56 are also used to store identification information related to the specific field device 30 attached to the CCM 10. Such information includes the model number of the field device 30, a unique ID tag identifying the field device 30 and attached CCM 10, other address and communications information (e.g., the baud rates at which the CCM can communicate) related to the CCM, description information related to the field. device 30 attached to the CCM, other user-supplied information, linking data related to the website of the manufacturer or supplier of the field device 30 or CCM 10 attached thereto, and linking data related to an electronic copy of the instruction manual available via the Internet for the field device 30 or CCM attached thereto.

Readers familiar with Bluetooth RF modules understand that they have their own processor and memory module in addition to the two-way radio. The memory of the Bluetooth RF Module may be used to store certain types of data associated with the CCM 10 and the attached field device 30 without deviating from the invention. Further, in some embodiments, and without deviating from the invention, it may be possible for the CCM 10 to rely for its operation exclusively on the processer of the Bluetooth RF module to reduce the number of components and the cost of manufacture associated therewith. This may become more likely as the processing power of the processors built into Bluetooth RF modules increases or for other reasons.

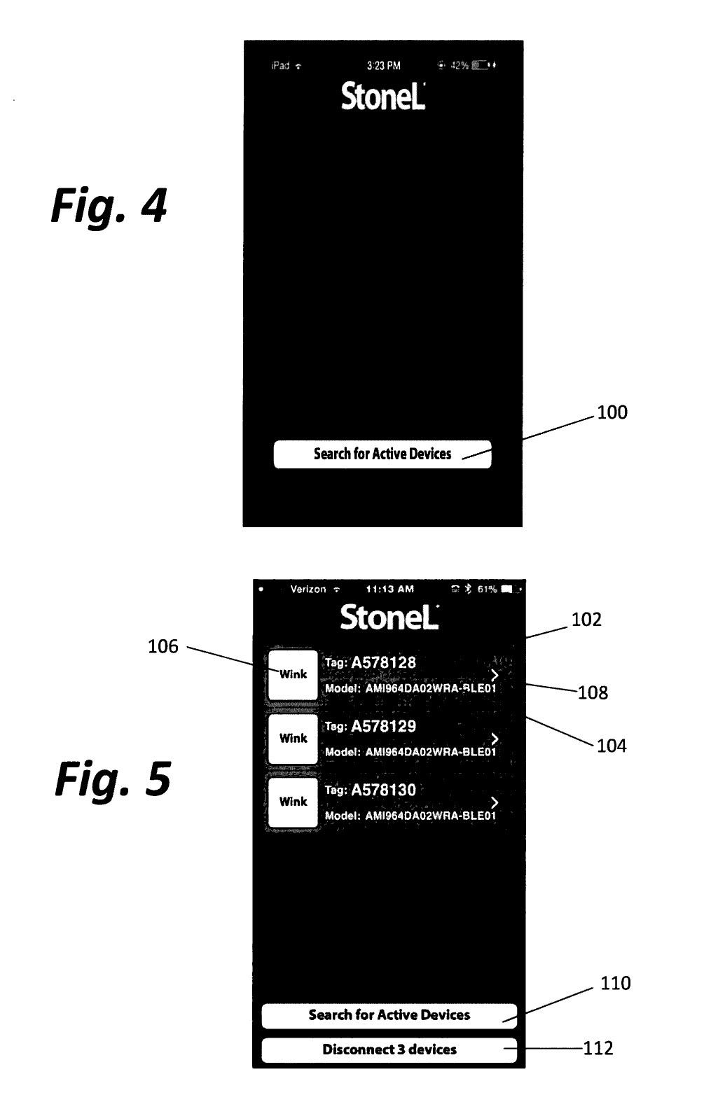

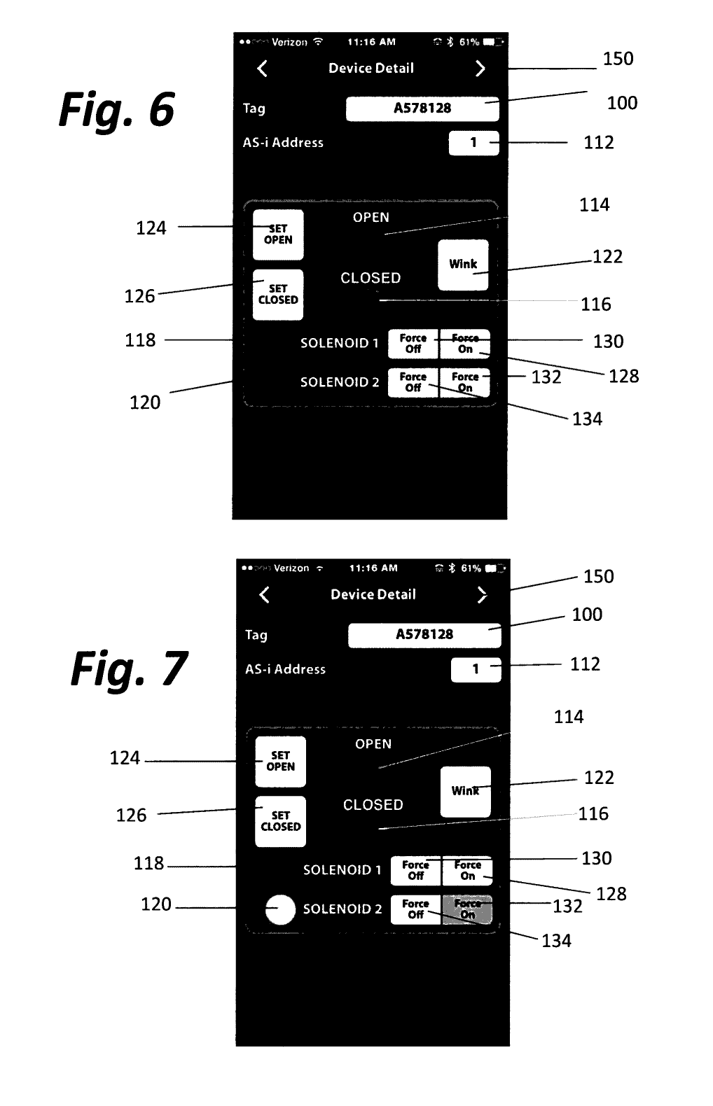

FIGS. 4-11 are examples of screens which may be displayed on the display of the smartphone 22 or the tablet computer 24. In the examples shown in FIGS. 4-11, the display of the smartphone 22 or tablet computer 24 is a touch screen. When the application is launched on the smartphone 22 or tablet computer 24, the screen shown in FIG. 4 is displayed- The user then taps the button 100 on the touch display labeled “Search for Active Devices”. The smartphone (or tablet) searches for signals transmitted by the CCMs 10 associated with the field devices 1-8 within communication range of the Bluetooth RF modules (more specifically, the radios incorporated therein) of the CCMs and smartphone (or tablet) and generates a display like that shown in FIG. 5.

FIG. 5 is an example of what may be displayed on the smartphone or tablet when three field devices are in range. Each field device and attached CCM 10 is identified by a unique ID tag 102 and the model number 104 of the field device. This information is retrieved by the processor 50 of the CCM 10 from the memory modules 54 and/or 56 and transmitted via the Bluetooth RF module 20 to the smartphone 22. While all three devices shown in FIG. 5 are the same model number, the system will work with different models of field devices as well The application software loaded on the general purpose mobile device (i.e., the smartphone 22 or tablet 24) provides this important functionality allowing a single general purpose mobile device to collect data and display data from and send instructions to a wide variety of field devices 30 coupled to CCM 10.

A “wink” button 106 is associated with each of the three devices identified on the display of FIG. 5. Pressing the “wink” button 106 for a particular device will cause the smartphone or tablet to send a signal to the address of the CCM 10 associated with that field device. This signal, when received by the CCM's Bluetooth RF module 20 and processed by the processor 50 of the CCM 10 will cause light emitting diodes (LEDs) 60-60 on the HMI 58 of the CCM 10 to blink providing a visual indication to the user allowing the user to identify the field device 30 and associated CCM 10 related to the tag number. In certain operating environments, an indicator other than a light source may prove more useful for providing such an identifying indication. In such cases, a such an indicator is provided as a part of the CCM and pressing the wink button 106 will cause the indicator on the CCM to provide an identifying indication.

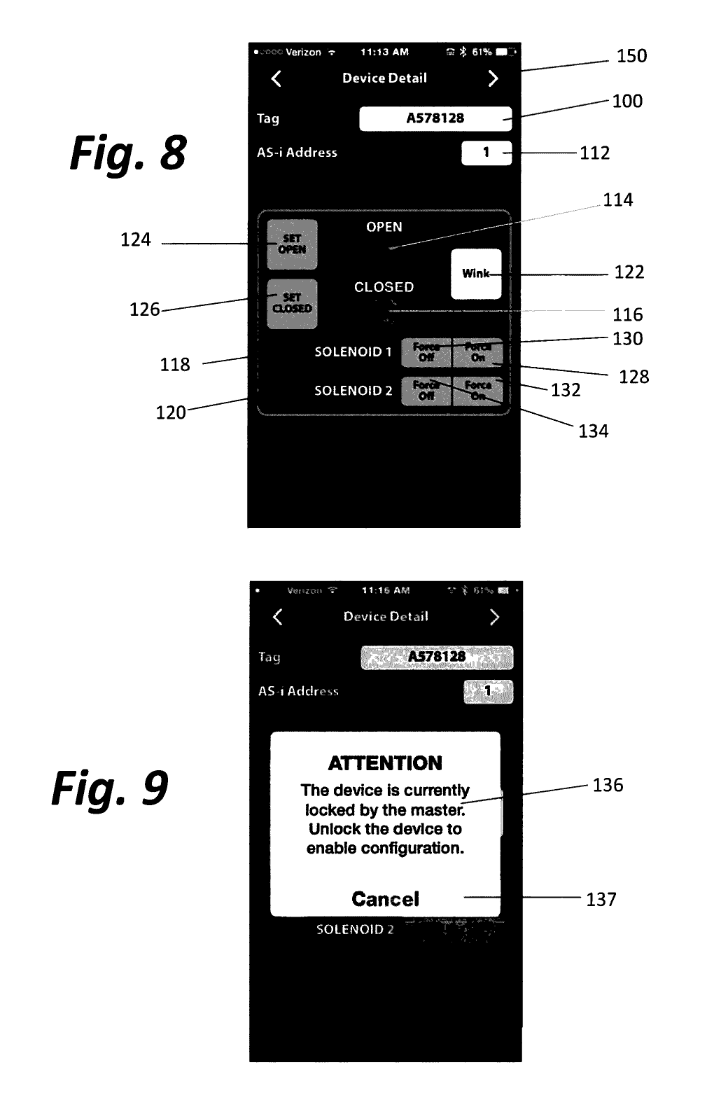

Also associated on the display of FIG. 5 for each of the three devices is an arrowhead 108 pointing to the right. Pushing on one of these arrowheads causes further information related to the specific field device 30 and attached CCM 10 to be displayed. Examples of such information being displayed are illustrated in FIGS. 6-10.

Before turning to a discussion of FIGS. 6-10, the reader will note that the display of FIG. 5 has two other buttons. The “Search for Active Devices” button 110 will cause the smartphone or tablet to search again for field devices 30 with attached CCMs 10 which are active and in the effective operating range of the radios of the Bluetooth RF modules of the CCMs and the GPMD. Pushing the “Disconnect 3 Devices” button 112 will cause the display of the GPMD to be cleared.

FIGS. 6 and 7 are examples of screens that might be displayed if field device 1 (or 2) and the CCM 10 of that device are in range and active when the right arrowhead 108, associated with that device shown in FIG. 5, is pressed. The displays shown in FIGS. 6 and 7 might also appear if a right arrow 108 in FIG. 5 associated with field devices 3-8 is depressed, but only if the PLC 14 has sent an unlock command to the CCM 10 attached to the field device. Only after such an unlock command has been processed by the processor 50 of the CCM 10 can the CCM and attached field device be controlled by the smartphone 22 or tablet computer 24.

There are alternative ways to switch the CCM 10 between the locked and unlocked condition. For example, the CCM 10 may default to the locked condition, but switch to the unlocked condition whenever a predetermined voltage is applied to the CCM and the CCM is not receiving a master control signal from a controller such as the PLC. Alternatively, the CCM 10 could default to an unlocked condition, but switch to a locked condition whenever it is under master control and receiving communication signals from a PLC or some other master controller. A preauthorized password transmitted from the GPMD to the CCM could also be used to unlock the CCM.

In FIGS. 6 and 7, certain information transmitted to the phone or tablet by the CCM 10 is displayed and certain command buttons are accessible. Specifically, the unique tag identifying the particular field devices 30 is listed. Also listed is the address protocol the device is using. This is listed in the AS-i Address field 112 of the display. Either of the two indicators 114 and 116 is illuminated providing an indication of whether the field device 30 (in this case a valve) is open or closed. Similar indicators 118 and 120 are provided to indicate whether the two solenoids controlling the valve are on or off. The AS-i address information displayed and which of the indicators 114-120 are illuminated depends on signals sent by the processor 50 via the Bluetooth module 20 of the CCM 10 to the phone or tablet.

Command buttons shown in FIGS. 6 and 7 include a “wink” button 122 which performs the same function as the “wink” button 106 of FIG. 5. Other buttons 124 and 126 allow the valve position sensor 38 to be calibrated to the “open” position or the “closed” position in the same manner as similarly labeled switches 70 and 72 of the HMI 58. Still other buttons 128-134 may be used to force either of the two solenoids on or off. In the example provided in FIG. 7, the “Force On” button associated with solenoid 2 has been activated. The button 132 will change color on the display and the indicator associated with solenoid 2 is also illuminated. When any of the buttons 122-134 are pressed, the phone or tablet sends command signals to the CCM 10 of the specific field device 30 which are received by the Bluetooth RF module and processed by the processor 50 of that CCM.

FIGS. 8 and 9 show screens displayed on the smartphone or tablet when the selected field device is one of field devices 3-8 and the PLC has not unlocked the field device and associated CCM 10. The data is still displayed in FIG. 8, but only the “wink” button is operational. If another button is pressed, the text message 136 illustrated in FIG. 9 is displayed. This text message is removed from the display by hitting the “cancel” button 137. Note that in FIG. 8, the non-active buttons are darkened (i.e., buttons 124-134) indicating they are not functional.

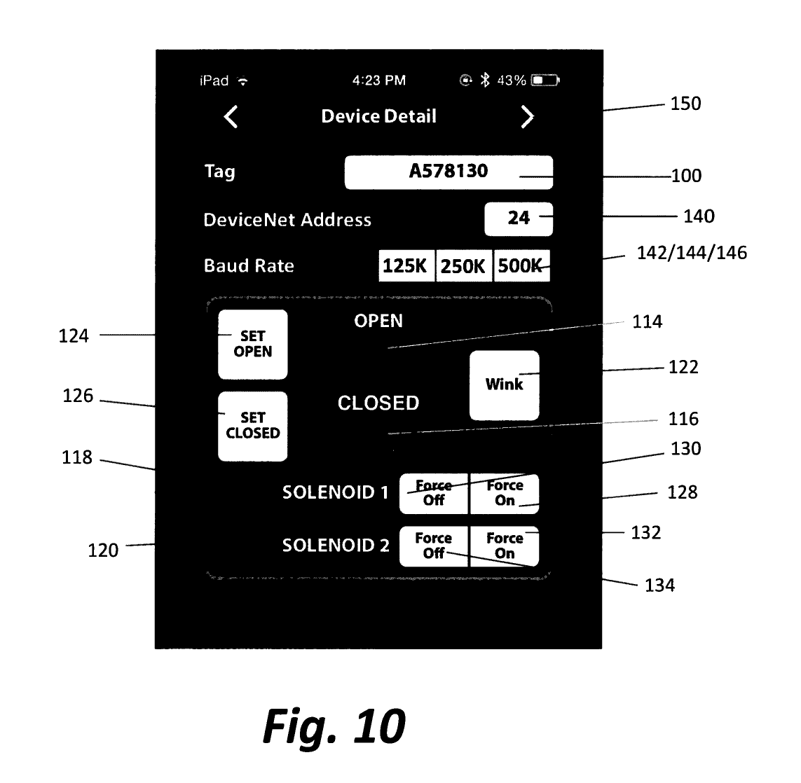

FIG. 10 shows a display activated in the same way as any of the displays shown in FIGS. 6-9, i.e., by depressing one of the right arrowheads 108 in FIG. 5. The display of FIG. 10 is for a different type, i.e., model, field device 30 than the display of FIGS. 6-9. The software application in the smartphone 22 or tablet computer 24 adjusts the display based upon the type of field device 30 or CCM 10 used with that field device and the information and control functions available for that type of field device and CCM. In the example of FIG. 10, the additional information being provided includes a DeviceNet address 140 and the user can select between three different baud rates for communications with that device by pushing the buttons 142, 144 or 146 associated with that baud rate. Otherwise, the same information and commands are available as in FIG. 6, for example. Again, the information displayed is based on data transmitted from the CCM 10 attached to the field device 30. That information is stored in the memory modules 54 and/or 56, retrieved by the processor 50 and transmitted by the processor via the Bluetooth RF module 20 to the phone or tablet.

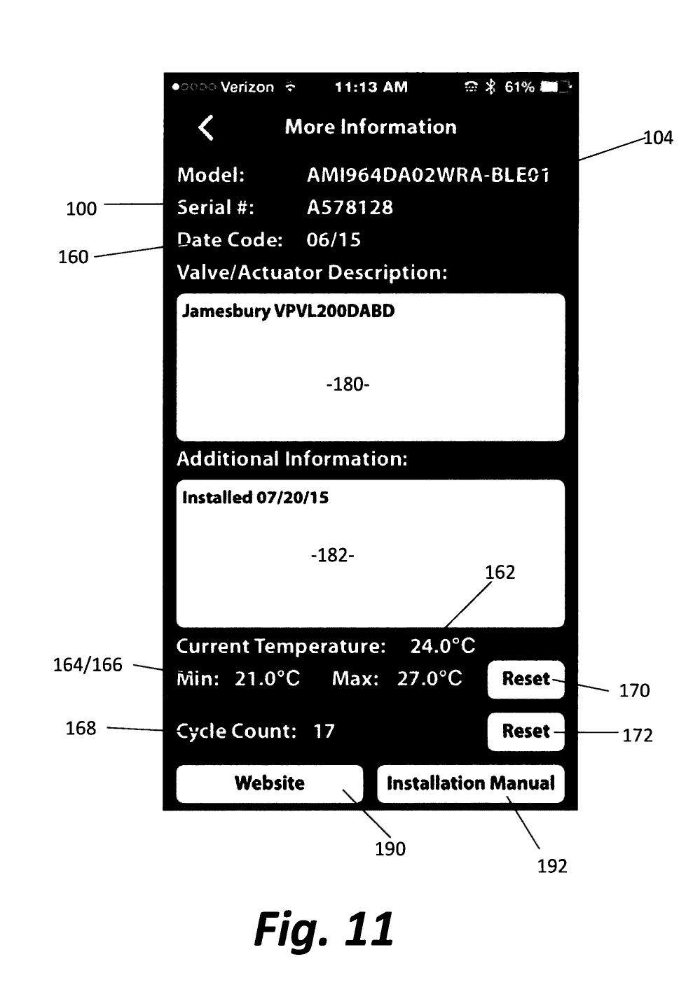

FIG. 11 shows another screen displayed by the application on the smartphone or tablet computer when the right arrowhead 150 on any of FIGS. 6-8 is pressed. A similar screen is displayed if the right arrowhead 150 of FIG. 10 is depressed. Nothing will happen if this arrow is depressed when the text message 136 is present, as shown in FIG. 9.

Additional information is provided in FIG. 11. This information includes the model number 104 and serial number (tag) 100 of the specific field device or attached CCM and a date code representing the month and year the field device was manufactured. Also displayed is the current temperature 162 at which the field device 30 is operating together with the minimum 164 and maximum 166 temperatures the field device 30 has operated at since it was last reset. A cycle count 168, i.e., how many times the valve opened or closed, is also provided. The minimum and maximum temperatures can be reset by hitting the associated reset button 170. Likewise, the cycle count can be reset by hitting the associated reset button 172.

To populate the current temperature field, the processor 50 processes data directly from the temperature sensor 36 or interrogates the memory module 54 to retrieve the last reported and stored temperature. This data is then delivered to the phone or tablet computer via the Bluetooth RF module 20. Upon arrival at the phone or tablet computer, the data is further processed for display in accordance with instructions contained in the application software loaded into the phone or tablet computer. Likewise, the date required to populate fields 164-168 are retrieved from memory module 54 by the processor 50 and transmitted to the phone or tablet via the Bluetooth RF module 20. Upon receipt by the phone or tablet, the data is processed by the processor of the phone or tablet computer, stored in the memory of the phone or tablet computer, and the appropriate fields are populated on the display of the phone or tablet computer.

When either of the reset buttons 170 and 172 are depressed, an addressed signal is sent by the phone or tablet computer to the Bluetooth RF module 20 of the CCM. Upon receipt, this signal is processed by the processor 50 and the memory locations in the memory module 54 storing the relevant data are cleared, More specifically, when reset button 170 is pressed, the memory locations storing the minimum and maximum temperatures are cleared and when the reset button 172 is pressed, the memory location storing the cycle count is cleared. The processor 50 will repopulate those memory locations with new data based on readings from the appropriate sensors (e.g. 36 and 38).

Two free-form fields 180 and 182 are shown in FIG. 11. Field 160 allows the user to associate a valve/actuator description with the specific device. When one presses on this field, a keyboard appears allowing the user to type in the desired description. Additional information can be entered in the field 182 in a similar fashion. Data so entered is transmitted by the phone or tablet computer to the Bluetooth RF module 20 of the CCM 10, processed by processor 50 and stored in one of the memory modules 54 and 56. In a similar fashion, a user can change the serial (tag) number information.

If the smartphone or tablet computer is connected to the internet, two other features are enabled. Pressing the website button 190 will send a command to the CCM 10 causing the processor 50 to access the aforementioned website linking information stored in the memory module of the CCM 10 and forward the linking information to the smartphone or tablet computer via the Bluetooth RF module 20 to launch a web browser of the phone or tablet. This may allow the user to view the website of the manufacturer or supplier of the field device using the web browser of the smartphone or tablet computer. Hitting the installation manual button 192 will cause the installation manual for the field device to be downloaded and displayed using the relevant linking information stored in the memory of the CCM.

Use of the smartphone or tablet computer is not limited to monitoring and control of the field devices and attached CCMs in the plant. The apparatus described above may also be employed for configuration of the field devices and attached CCM at the time of manufacture at the factory and/or at the time of installation at the plant.

At the factory, a predetermined voltage is applied to the CCM 10 to switch the CCM 10 from a locked condition to in an unlocked condition. Using the GPMD the smartphone or tablet computer), a pre-determined, but unpublicized sequence of actions are performed within a predetermined time window to cause the GPMD to display a login screen. An administrative password is then entered. Upon entry of a preauthorized administrative password, a setup signal is sent by the GPMD to the CCM. Upon receipt of this signal, the CCM switches from the unlocked condition to a setup condition. Also, at least one settings page is displayed on the GPMD. Various factory settings and data are provided by completing fields on the settings pages. Examples of such settings and data include the serial number, model number and date code of the field device. These are then transmitted by the GPMD to the CCM 10 and stored in one of the memory modules of the CCM, e.g. non-volatile memory module 54. Other information may be stored in the memory of the CCM in a similar manner at this time. Additional examples include internet links to the manufacturer's website and to an electronic copy of the instruction manual for the field device and CCM. After the desired configuration data has been delivered to and stored in the memory of the CCM, the user logs out. At logout, a signal is sent to the CCM causing the CCM to switch from the setup condition back to the unlocked condition thereby disabling the ability to enter or change the settings information until a preauthorized administrative password entered again.

Other information can be supplied in a similar fashion at the time of installation of the field device and CCM at the plant. Such information typically might include the address of the CCM, a code indicative of the address type (e.g., 1=“As-i Address”, 2=“AS-i Address +A or B”, 3=“DeviceNet Address”), a code indicative of a specific baud rate for communications, etc. Likewise, the memory locations in which temperatures, cycle counts and the like are stored can be cleared and the sensors can be calibrated thereby prepared for use.

It is also possible to automate the process of setting up a series of field devices and associated CCMs. In addition to the above-described application residing on the general purpose mobile device, a spreadsheet containing the specific setup data for each of the series of field devices and attached CCMs may be prepared and loaded onto the general purpose mobile device. A macro is also loaded onto the general purpose mobile device which operates to extract data from the spreadsheet and supply it to the application in a way that causes the application to load forward the data to the CCMs for storage in the memory of the CCM.

The foregoing description is intended to explain, but not limit the invention which is defined by the following claims. As noted above, various types of field devices may be used. The specific design of a CCM may be adapted to the particular type of field device with which it is used. A GPMD other than a smartphone or tablet computer may be used. The GPMD may employ a communications protocol other than Bluetooth. The CCMs may be altered to enable use of a GPMD using a communications protocol other than Bluetooth. These and other modifications may all be made without deviating from the invention.

What is claimed is:

1. A setup, monitor and control apparatus comprising:
a. a plurality of field devices, each of said field devices having (i) a communications and control module (CCM) coupled thereto, and (ii) a sensor for monitoring a condition of the field device, wherein said sensor is adapted to send signals to the CCM and the CCM is adapted to process said signals, wherein the CCM includes a human machine interface (HMI), a processor, a clock, at least one memory module and a first short range radio adapted for two-way communication, and wherein the processor, pursuant to a preselected set of instructions, is adapted to (i) store in said at least one memory module identification and address information concerning the field device and CCM, (ii) store information based on signals received from the at least one sensor and processed by the processor, (iii) retrieve data from memory and transmit such data using the first short range radio, and (iv) receive and process command signals received using the first short range radio; and
b. a general purpose, commercially available, off-the-shelf mobile device (GPMD) having a display and a second short range radio adapted for communication with the first short range radio of each CCM attached to said plurality of field devices within the range of the first and second short range radios, said GPMD controlled, at least in part, by an application program, such that the GPMD is adapted to interrogate each CCM in the range of the first and second short range radios to retrieve and display identification information related to each such CCM, selectively send control signals to each such CCM, and on a selective basis interrogate each such CCM to obtain and display information related to the operation of the field device attached to the CCM.

2. The setup, monitor and control apparatus of claim 1 further comprising at least one actuator controlled by the CCM which, in turn, controls the field device.

3. The setup, monitor and control apparatus of claim 1 wherein the CCM has an unlocked condition and a locked condition.

4. The setup, monitor and control apparatus of claim 3 wherein the CCM is adapted to switch from the locked to the unlocked condition upon at least one of (i) receipt of an unlock signal from a programmable logic controller, (ii) the presence of a predetermined voltage together with the absence of a master control signal, and (iii) transmission of a preauthorized password from the GPMD to the CCM,

5. The setup, monitor and control apparatus of claim 3 wherein the GPMD is adapted to send a setup signal to the CCM in response to a sequence of predetermined actions within a predetermined period of time followed by receipt of a preauthorized password, and the CCM is adapted to switch to a setup condition upon receipt of the setup signal.

6. The setup, monitor and control apparatus of claim 1 wherein at least some of said CCMs are coupled to a controller.

7. The setup, monitor and control apparatus of claim 1 wherein the controller is adapted to send control signals to at least one of the CCM coupled to the controller, which are processed by the CCM to cause the CCM to perform at least one predetermined function.

8. The setup, monitor and control apparatus of claim 1 wherein, when a CCM is in a locked condition, the GPMD is able to receive and display information related to the operation of the field device attached to that CCM, but is unable to send at least some of the control signals to that CCM that can be sent by the GPMD to that CCM when that CCM is in the unlocked condition.

9. The setup, monitor and control apparatus of claim 1 wherein the HMI of each CCM has at least one indicator and the GMPD is adapted to selectively send an instruction to a selected one of the CCMs causing the indicator of the selected one of the CCMs to provide an identifying indication.

10. The setup, monitor and control apparatus of claim 9 wherein said indicator will provide the identifying indication even when that CCM is in a locked condition.

11. The setup, monitor and control apparatus of claim 1 wherein the GPMD is adapted to simultaneously present on its display identification information related to each field device attached to a CCM within the range of the first short range radios of the CCMs and the second short range radio of the GPMD.

12. The setup, monitor and control apparatus of claim 11 wherein the display of the GPMD is divided into separate areas, each of said areas associated with one of the field devices attached to a CCM within said range of the first and second short range radios such that the identification information related to each field device attached to a CCM within said range of the first and second short range radios is displayed in the separate area of the display associated therewith.

13. The setup, monitor and control apparatus of claim 12 wherein the display of the GPMD is a touch screen display adapted to permit selection of one of the field devices by touching an area of the display associated with said one of the field devices, and upon such selection, the GPMD displays information related to the operation of said one of the field devices.

14. The setup, monitor and control apparatus of claim 12 wherein the display of the GPMD is a touch screen display adapted to permit selection of one of the field devices by touching an area of the display associated with said one of the field devices, and upon such selection, the GPMD displays information related to the operation of said one of the field devices and is adapted to be operated to send at least one control signal to a CCM attached to the selected one of the field devices.

15. The setup, monitoring and control apparatus of claim 1 wherein the GPMD is selected from a group consisting of smartphones and tablet computers.

16. The setup, monitoring and control apparatus of claim 1 wherein said GPMD further comprised a spreadsheet and a macro adapted to work in conjunction with said application to automate the setup of a plurality of field devices and attached CCMs.

17. The setup, monitoring and control apparatus of claim 1 wherein at least one of said plurality of field devices is a valve.

18. The setup, monitoring and control apparatus of claim 17 wherein said valve is moved between an open position and a closed position by at least one valve actuator and said at least one valve actuator is controlled by said CCM.

19. The setup, monitoring and control apparatus of claim 17 wherein said sensor is selected from a group consisting of a temperature sensor and a valve position sensor.

20. The setup, monitoring and control apparatus of claim 1 further comprising at least one actuator and the sensor monitors the condition of the actuator.
